(19) United States
(12) Patent Application Publication
(10) Pub. No.: US 2025/0371423 A1
(43) Pub. Date: Dec. 4, 2025

(54) ELECTRONIC DEVICE PROVIDING RESULTS OUTPUT THROUGH SHARED ARTIFICIAL INTELLIGENCE MODEL TO MULTIPLE APPLICATIONS AND METHOD FOR CONTROLLING THE SAME

(71) Applicant: SAMSUNG ELECTRONICS CO., LTD., Suwon-si (KR)

(72) Inventor: Jinbum PARK, Suwon-si (KR)

(21) Appl. No.: 19/220,632

(22) Filed: May 28, 2025

Related U.S. Application Data
(63) Continuation of application No. PCT/KR2025/007255, filed on May 28, 2025.

(30) Foreign Application Priority Data
May 29, 2024 (KR) 10-2024-0069878

(51) Int. Cl. G06N 20/00

(52) U.S. Cl. CPC G06N 20/00

(57) ABSTRACT

An electronic device may comprise: a memory, and at least one processor, comprising processing circuitry. At least one processor, individually and/or collectively, may be configured to cause the electronic device to: transmit, to a shared application, first user input data input through a first application corresponding to a first vendor and second user input data input through a second application corresponding to a second vendor, stored in the memory, train a first artificial intelligence model of the shared application based on the first user input data and the second user input data, estimate results of a third user input data input through the first application or the second application, through the first artificial intelligence model, based on training the artificial intelligence model, and determine a priority for the estimated results and transmit information about the determined priority and the estimated results to the first application or the second application.

### CROSS-REFERENCE TO RELATED APPLICATIONS

This application is a continuation of International Application No. PCT/KR2025/007255 designating the United States, filed on May 28, 2025, in the Korean Intellectual Property Receiving Office and claiming priority to Korean Patent Application No. 10-2024-0069878, filed on May 29, 2024, in the Korean Intellectual Property Office, the disclosures of each of which are incorporated by reference herein in their entireties.

### BACKGROUND

### Field

The disclosure relates to an electronic device providing results output through a shared artificial intelligence model to a plurality of applications and a method for controlling the same.

### Description of Related Art

More and more services and additional functions are being provided through electronic devices, e.g., smartphones, or other portable electronic devices. To meet the needs of various users and raise use efficiency of electronic devices, communication service carriers or device manufacturers are jumping into competitions to develop electronic devices with differentiated and diversified functionalities. Accordingly, various functions that are provided through wearable devices are evolving more and more.

The above-described information may be provided as related art for the purpose of helping understanding of the disclosure. No assertion or determination is made as to whether any of the foregoing is applicable as background art in relation to the disclosure.

In conventional machine learning, e.g., federated learning, an electronic device may process user data input through the electronic device instead of user data, and transmit the processing result to a server. The server according to the conventional art may generate a global model based on results obtained from a plurality of electronic devices. The server according to the conventional art may transmit the generated global model to each electronic device. According to the conventional art, the electronic device may obtain the result of performing a machine learning process even without transmitting the user data input through the electronic device to the server. However, the machine learning method according to the conventional art relies on an external server. Further, the machine learning method according to the conventional art performs learning only with model parameters rather than actually input user data and, thus, cannot guarantee accuracy and/or quality of machine learning results.

### SUMMARY

Embodiments of the disclosure may provide an electronic device capable of providing the user with results with enhanced quality and/or accuracy as compared with the conventional art by training an artificial intelligence model using user data input through a plurality of applications provided by various vendors based on confidential computing technology.

Embodiments of the disclosure may provide an electronic device capable of providing the user with results with enhanced quality and/or accuracy as compared with the conventional art by training an artificial intelligence model using user data actually input to the electronic device based on confidential computing technology.

Embodiments of the disclosure may provide a method for controlling an electronic device capable of providing the user with results with enhanced quality and/or accuracy as compared with the conventional art by training an artificial intelligence model using user data input through a plurality of applications provided by various vendors based on confidential computing technology.

Embodiments of the disclosure may provide a method for controlling an electronic device capable of providing the user with results with enhanced quality and/or accuracy as compared with the conventional art by training an artificial intelligence model using user data actually input to the electronic device based on confidential computing technology.

An electronic device according to an example embodiment of the disclosure may comprise: memory, and at least one processor, comprising processing circuitry, wherein at least one processor, individually and/or collectively, may be configured to cause the electronic device to: transmit, to a shared application, first user input data input through a first application, corresponding to a first vendor and stored in the memory, and second user input data input through a second application, corresponding to a second vendor and stored in the memory, train a first artificial intelligence model of the shared application based on the first user input data and the second user input data, estimate results of a third user input data input through the first application and/or the second application, through the first artificial intelligence model, based on training the artificial intelligence model, and determine a priority for the estimated results and transmit information about the determined priority and the estimated results to the first application and/or the second application.

A method for controlling an electronic device according to an example embodiment of the disclosure may comprise: transmitting, to a shared application, first user input data input through a first application, corresponding to a first vendor and stored in memory of the electronic device, and second user input data input through a second application, corresponding to a second vendor and stored in the memory, training a first artificial intelligence model of the shared application based on the first user input data and the second user input data, estimating results of a third user input data input through the first application and/or the second application, through the first artificial intelligence model, based on training the artificial intelligence model, and determining a priority for the estimated results and transmitting information about the determined priority and the estimated results to the first application or the second application.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a flowchart illustrating an example function or operation in which an electronic device (e.g., a first artificial intelligence model) performs training using first user data input through a plurality of applications and provides result data for second user data, output based on a result of the training to at least one application according to various embodiments;

FIG. 3A is a block diagram illustrating an example configuration of an electronic device including an artificial intelligence model (e.g., a second artificial intelligence model and a third artificial intelligence model) respectively corresponding to a plurality of applications (e.g., a first application and a second application) separately from a shared artificial intelligence model (e.g., a first artificial intelligence model) according to various embodiments;

FIG. 3B is a block diagram illustrating an example configuration of an electronic device including a shared artificial intelligence model (e.g., a first artificial intelligence model) alone without including artificial intelligence models (e.g., a second artificial intelligence model and a third artificial intelligence model) respectively corresponding to a plurality of applications (e.g., a first application and a second application) according to various embodiments;

FIG. 4A is a diagram illustrating an example function or operation of controlling a first application and a second application to provide a shared application with first input data, first result data, and first feedback information associated with a first application and second input data, second result data, and second feedback information associated with a second application for training a first artificial intelligence model according to various embodiments;

FIG. 4B is a diagram illustrating an example function or operation of controlling a first application and a second application to provide a shared application with first input data and first feedback information associated with a first application and second input data and second feedback information associated with a second application for training a first artificial intelligence model according to various embodiments;

FIG. 5A is a diagram illustrating an example function or operation of controlling a first application to provide a shared application with first input data and first result data associated with the first application to obtain result data estimated from an artificial intelligence model of the shared application according to various embodiments;

FIG. 5B is a diagram illustrating an example function or operation of controlling a first application to provide a shared application with first input data associated with the first application to obtain result data estimated from an artificial intelligence model of the shared application according to various embodiments;

FIGS. 6A and 6B are diagrams illustrating an example function or operation of controlling a shared application to provide a first application with result data estimated by an artificial intelligence model (e.g., a first artificial intelligence model) of the shared application according to various embodiments;

FIG. 7 is a flowchart illustrating an example function or operation of providing at least one application (e.g., a first application) with result data estimated by an artificial intelligence model (e.g., a first artificial intelligence model) of a shared application according to a data policy, according to various embodiments; and

FIGS. 8A and 8B are diagrams illustrating an example function or operation in which an electronic device provides a user with result data different from result data before training, based on a result of training based on input data input through a plurality of applications according to various embodiments.

### DETAILED DESCRIPTION

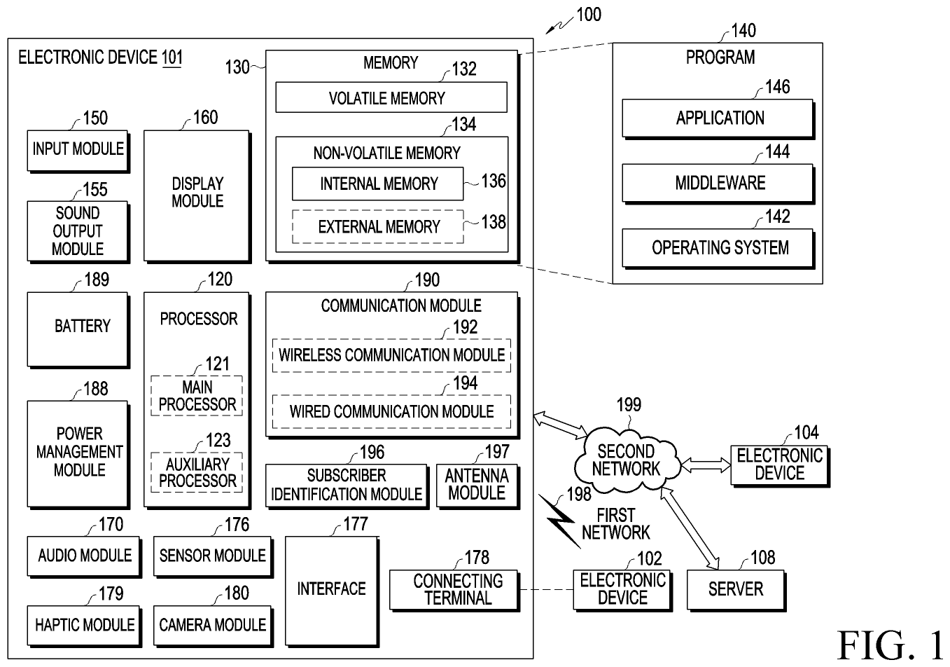

FIG. 1 is a block diagram illustrating an example electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

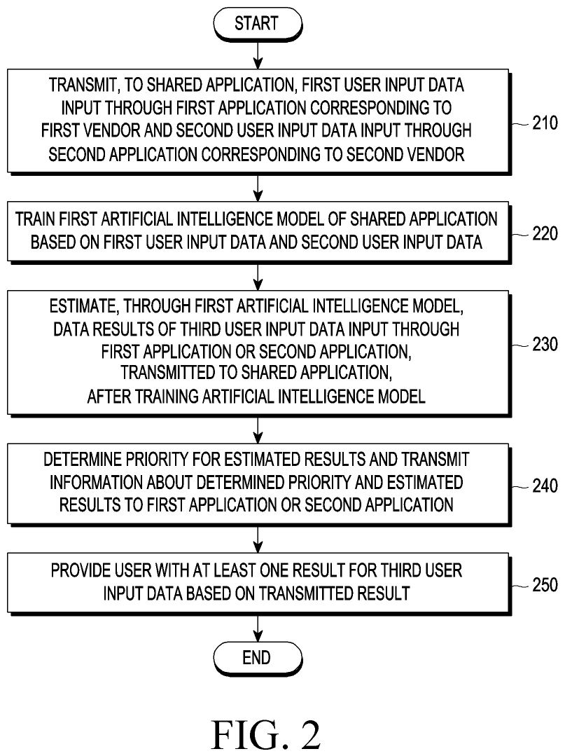

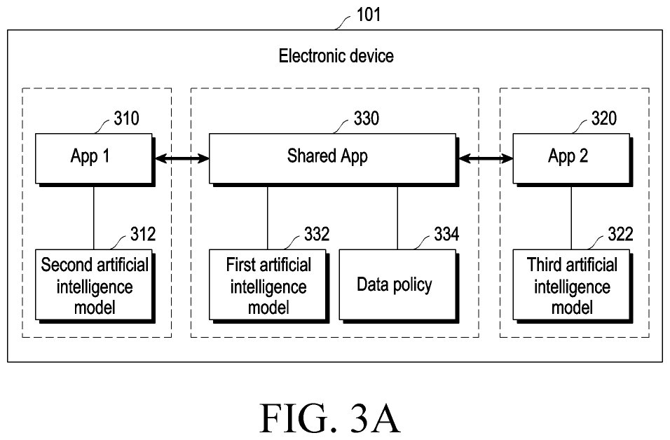

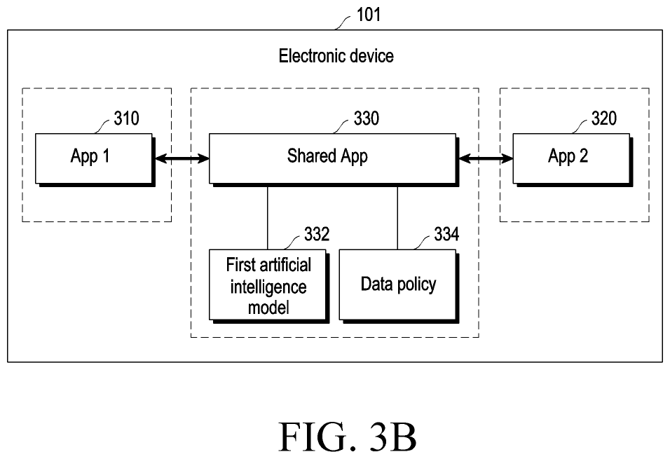

FIG. 2 is a flowchart illustrating an example function or operation in which an electronic device 101 (e.g., a first artificial intelligence model 332 (refer to FIGS. 3A and 3B) performs training using first user data input through a plurality of applications and provides result data for second user data, output based on a result of the training to at least one application according to various embodiments.

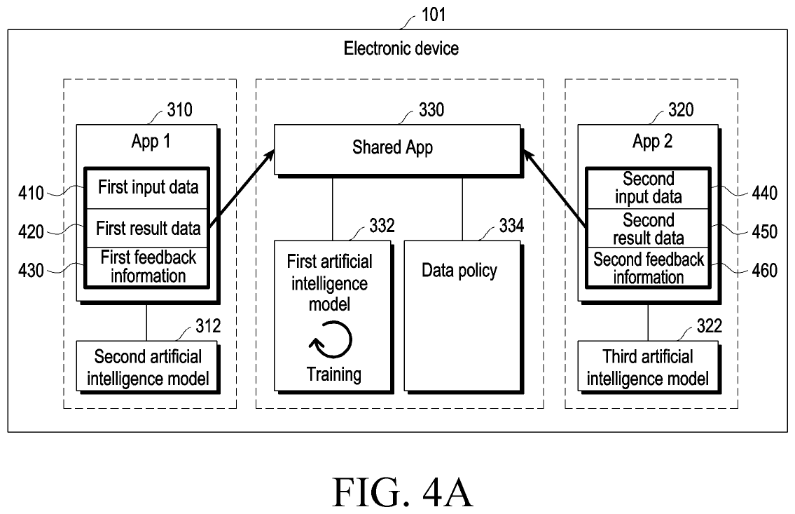

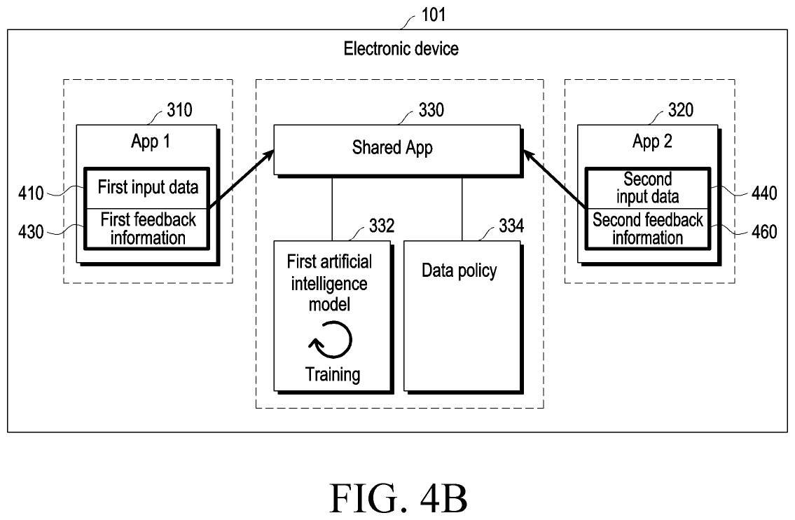

Referring to FIG. 2, in operation 210, the electronic device 101 according to an embodiment of the disclosure may transmit first user input data (e.g., the first input data 410 of FIG. 4A) input through a first application (e.g., first application 310 of FIGS. 3A and 3B) corresponding to a first vendor (e.g., Samsung®) and second user input data (e.g., the second input data 440 of FIG. 4A) input through a second application (e.g., second application 320 of FIGS. 3A and 3B) corresponding to a second vendor to a shared application (e.g., shared application 330 of FIGS. 3A and 3B). In the electronic device 101 according to an embodiment of the disclosure, in operation 220, a first artificial intelligence model (e.g. first artificial intelligence model 332 of FIGS. 3A and 3B) may perform training based on the first user input data (e.g., the first input data 410 of FIG. 4A) and the second user input data (e.g., the second input data 440 of FIG. 4A).

FIG. 3A is a block diagram illustrating an example configuration of an electronic device 101 including an artificial intelligence model (e.g., a second artificial intelligence model 312 and a third artificial intelligence model 322) respectively corresponding to a plurality of applications (e.g., a first application 310 and a second application 320) separately from a shared artificial intelligence model (e.g., a first artificial intelligence model 332) according to various embodiments.

Referring to FIG. 3A, the electronic device 101 according to an embodiment of the disclosure may include a shared application 330, a first artificial intelligence model (e.g., including circuitry and/or executable program instructions) 332 and a data policy 334 stored in the electronic device 101 in association with the shared application. The shared application 330, the first artificial intelligence model 332 and the data policy 334 stored in the electronic device 101 in association with the shared application according to an embodiment of the disclosure may be at least temporarily stored in the memory 130. The first artificial intelligence model 332 according to an embodiment of the disclosure may include an artificial intelligence model (e.g., a reward model) configured to estimate and/or determine priorities for a plurality of result values based on the user's preference. The shared application 330 according to an embodiment of the disclosure may include an application configured to manage the first artificial intelligence model 332. The first application 310 according to an embodiment of the disclosure may include an application (e.g., Samsung® Bixby®) provided by a vendor of the electronic device 101. The first application 310 according to an embodiment of the disclosure may include a language model. The second artificial intelligence model (e.g., including circuitry and/or executable program instructions) 312 according to an embodiment of the disclosure may be an artificial intelligence model stored in the electronic device 101 in association with the first application 310. The second artificial intelligence model 312 according to an embodiment of the disclosure may include an artificial intelligence model configured to estimate and/or determine result data of input data input through the first application 310. The second application 310 according to an embodiment of the disclosure may include an application (e.g., a third party application) provided by a vendor other than the vendor of the electronic device 101. The first application 310 according to an embodiment of the disclosure may include a language model. The third artificial intelligence model (e.g., including circuitry and/or executable program instructions) 322 according to an embodiment of the disclosure may be an artificial intelligence model stored in the electronic device 101 in association with the second application 320. The third artificial intelligence model 322 according to an embodiment of the disclosure may include an artificial intelligence model configured to estimate and/or determine result data of input data input through the second application 320. The data policy 334 according to an embodiment of the disclosure may include a policy for determining an eligibility for whether at least one application (e.g., the first application 310) may receive result data estimated by the first artificial intelligence model 332. The data policy 334 according to an embodiment of the disclosure may include, e.g., a policy established to determine that it is eligible to receive result data estimated by the first artificial intelligence model 332 only for applications that have provided data a designated number of times or more for the shared application 330. According to an embodiment of the disclosure, data stored for the first application 310 may not be directly transmitted to the second application 320.

FIG. 3B is a block diagram illustrating an example configuration of an electronic device 101 including a shared artificial intelligence model (e.g., a first artificial intelligence model 332) alone without including artificial intelligence models (e.g., a second artificial intelligence model 312 and a third artificial intelligence model 322) respectively corresponding to a plurality of applications (e.g., a first application 310 and a second application 320) according to an embodiment of the disclosure. Referring to FIG. 3B, the electronic device 101 according to an embodiment of the disclosure may include a shared application 330, a first artificial intelligence model 332 and a data policy 334 stored in the electronic device 101 in association with the shared application. The shared application 330, the first artificial intelligence model 332 and the data policy 334 stored in the electronic device 101 in association with the shared application according to an embodiment of the disclosure may be at least temporarily stored in the memory 130. The first artificial intelligence model 332 according to an embodiment of the disclosure may include an artificial intelligence model configured to estimate and/or determine priorities for a plurality of result values based on the user's preference. The shared application 330 according to an embodiment of the disclosure may include an application configured to manage the first artificial intelligence model 332. The first application 310 according to an embodiment of the disclosure may include an application (e.g., Samsung® Bixby®) provided by a vendor of the electronic device 101. The second application 310 according to an embodiment of the disclosure may include an application (e.g., a third party application) provided by a vendor other than the vendor of the electronic device 101. The data policy 334 according to an embodiment of the disclosure may include a policy for determining an eligibility for whether at least one application (e.g., the first application 310) may receive result data estimated by the first artificial intelligence model 332.

The first application 310, the second application 320, and the shared application 330, according to an embodiment of the disclosure, may be operated under a confidential computing environment. The confidential computing environment according to an embodiment of the disclosure may be in a state in which the corresponding code is disclosed, and may include a computing environment capable of attesting the corresponding code in the electronic device 101 and/or a third party device. The confidential computing environment according to an embodiment of the disclosure may include a computing environment in which security for the application may be guaranteed even when the operating system (OS) having a higher authority than an application operating in an application layer is hacked. The confidential computing environment according to an embodiment of the disclosure may include a computing environment in which even the vendor (e.g., Samsung®) of the electronic device 101 may not identify data stored in the application (e.g., the first application 310 and/or the second application 320). The dashed line illustrated in FIGS. 3A and 3B indicates that the first application 310, the second application 320, and the shared application 330 operate under the confidential computing environment. The first application 310, the second application 320, and the shared application 330 according to an embodiment of the disclosure may perform communication using a secure channel, and the secure channel may include a communication channel protected under the confidential computing environment.

FIG. 4A is a diagram illustrating an example function or operation of controlling a first application 310 and a second application 320 to provide a shared application 330 with first input data 410, first result data 420, and first feedback information 430 associated with a first application 310 and second input data 440, second result data 450, and second feedback information 460 associated with a second application 320 for training a first artificial intelligence model 332 according to various embodiments.

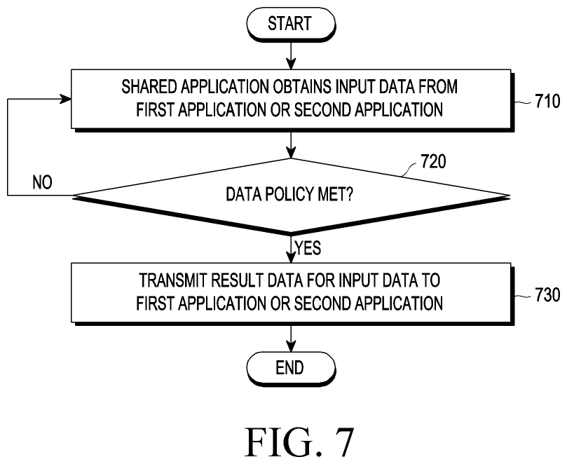

Referring to FIG. 4A, the electronic device 101 (e.g., the first application 310) according to an embodiment of the disclosure may call a function (e.g., feed_data (input, output)) configured to transmit the first input data 410, the first result data 420, and the first feedback information 430 to the shared application 330. The electronic device 101 (e.g., the first application 310) according to an embodiment of the disclosure may transmit the first input data 410, the first result data 420, and the first feedback information 430 to the shared application 330 through a designated function. Similarly, the electronic device 101 (e.g., the second application 320) according to an embodiment of the disclosure may call a designated function (e.g., feed_data (input, output) configured to transmit the second input data 440, the second result data 450, and the second feedback information 460 to the shared application 330. The electronic device 101 (e.g., the second application 320) according to an embodiment of the disclosure may transmit the second input data 440, the second result data 450, and the second feedback information 460 to the shared application 330 through a designated function. The first input data 410 according to an embodiment of the disclosure may include a user utterance such as, e.g., “Show me photos recently stored in the gallery and descriptions of the photos.” The first result data 420 according to an embodiment of the disclosure may include, e.g., at least one result (e.g., at least one image, and descriptions according to various description methods of the image) for the user's utterance (e.g., “Show me photos recently stored in the gallery and descriptions of the photos”) and/or priority information about the result. The first feedback information 430 according to an embodiment of the disclosure may include user feedback (e.g., satisfaction) on any one result finally provided to the user based on priority. The first artificial intelligence model 332 according to an embodiment of the disclosure may perform learning (e.g., training) using the first input data 410, the first result data 420, and the first feedback information 430. The second input data 410 according to an embodiment of the disclosure may include a user utterance such as, e.g., “Show me photos recently stored in the gallery and descriptions of the photos.” The second result data 450 according to an embodiment of the disclosure may include, e.g., at least one result (e.g., at least one image, and descriptions according to various description methods of the image) for the user's utterance (e.g., “Show me photos recently uploaded and descriptions of the photos”) and/or priority information about the result. The second feedback information 460 according to an embodiment of the disclosure may include user feedback (e.g., satisfaction) on any one result finally provided to the user based on priority. The first artificial intelligence model 332 according to an embodiment of the disclosure may perform learning (e.g., training) using the second input data 440, the second result data 450, and the second feedback information 460. Training of the first artificial intelligence model 332 according to an embodiment of the disclosure may be performed when the electronic device 101 (e.g., the first application 310) has the authority to call the first artificial intelligence model 332. The electronic device 101 (e.g., the shared application 330) according to an embodiment of the disclosure may determine whether the first application 310 and/or the second application 320 has the authority to call the first artificial intelligence model 332 based on the data policy 334. The electronic device 101 (e.g., the shared application 330) according to an embodiment of the disclosure may allow the first application 310 and/or the second application 320 to call the first artificial intelligence model 332 when it is determined that the first application 310 and/or the second application 320 has the authority to call the first artificial intelligence model 332. The electronic device 101 (e.g., the first application 310) according to an embodiment of the disclosure may call a designated function (e.g., run (input, output)) configured to call the first artificial intelligence model 332 if the call authority is allowed from the shared application 330. The electronic device 101 (e.g., the first artificial intelligence model 332) according to an embodiment of the disclosure may perform training based on data transmitted from each application if the first artificial intelligence model 332 is called through a designated function (e.g., run (input, output)). The data policy 334 according to an embodiment of the disclosure is described in greater detail below with reference to FIG. 7. The electronic device 101 (e.g., the shared application 330) according to an embodiment of the disclosure may provide a result according to the priority for the first result data and a result according to the priority for the second result data to the first application 310 and the second application 320, respectively, in the training process.

FIG. 4B is a diagram illustrating an example function or operation of controlling a first application 310 and a second application 320 to provide a shared application 330 with first input data 410 and first feedback information 430 associated with a first application 310 and second input data 440 and second feedback information 460 associated with a second application 320 for training a first artificial intelligence model 332 according to various embodiments.

Referring to FIG. 4B, the electronic device 101 (e.g., the first application 310) according to an embodiment of the disclosure may call a designated function (e.g., feed_data (input, output)) configured to transmit the first input data 410 and the first feedback information 430 to the shared application 330. According to an embodiment of the disclosure, when the second artificial intelligence model 312 and the third artificial intelligence model 322 are not included, data corresponding to the output value in the designated function may not be included in the designated function (e.g., feed_data (input, output)). Since data corresponding to the output value according to an embodiment of the disclosure may be estimated and/or determined by the first artificial intelligence model 332, data corresponding to the output value in the designated function may not be included in the designated function (e.g., feed_data (input, output)). The electronic device 101 (e.g., the first application 310) according to an embodiment of the disclosure may transmit the first input data 410 and the first feedback information 440 to the shared application 330 through a designated function. Similarly, the electronic device 101 (e.g., the second application 320) according to an embodiment of the disclosure may call a designated function (e.g., feed_data (input, output)) configured to transmit the second input data 440 and the second feedback information 460 to the shared application 330. The electronic device 101 (e.g., the second application 320) according to an embodiment of the disclosure may transmit the second input data 440 and the second feedback information 460 to the shared application 330 through a designated function. The first artificial intelligence model 332 according to an embodiment of the disclosure may perform learning (e.g., training) using the first input data 410, the first feedback information 430, the second input data 440, and the second feedback information 460.

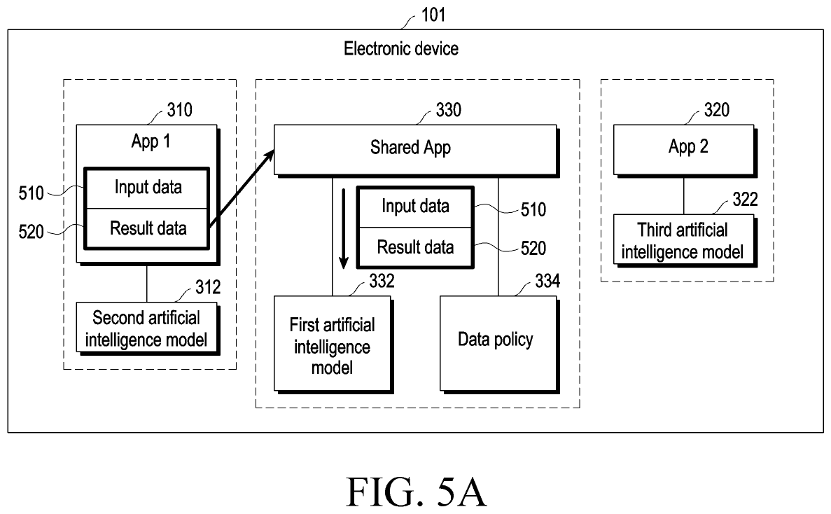

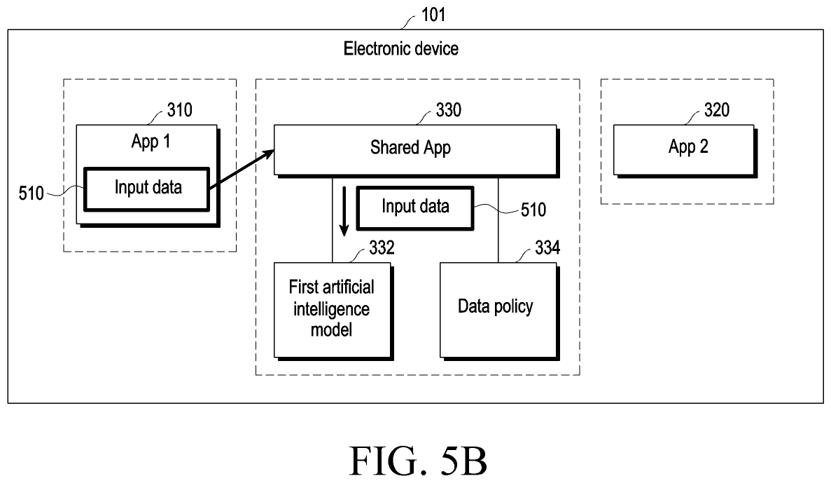

Referring back to FIG. 2, in operation 230, the electronic device 101 according to an embodiment of the disclosure may estimate, through the first artificial intelligence model 332, the results of the third user input data (e.g., the input data 510 (refer, e.g., to FIGS. 5A and 5B) input through the first application 310 or the second application 320, transmitted to the shared application 330 after the artificial intelligence model (e.g., the first artificial intelligence model 332) performs training. The electronic device 101 according to an embodiment of the disclosure may determine priority for the estimated results and transmit information about the estimated results and the determined priority to the first application 310 or the second application 320 in operation 240 of FIG. 2.

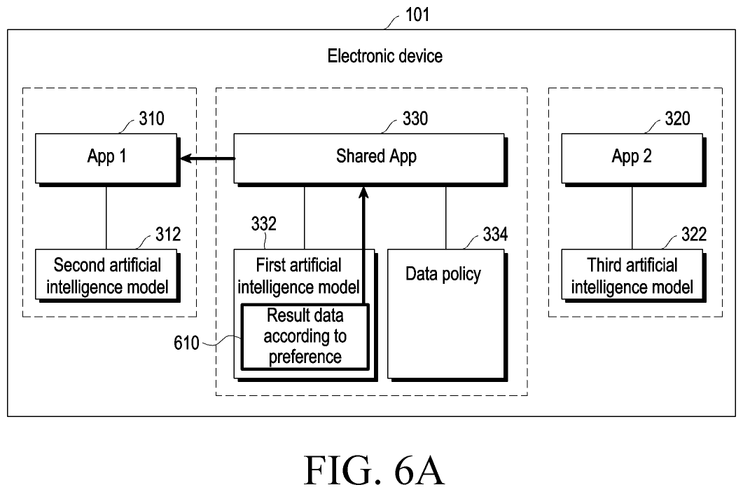

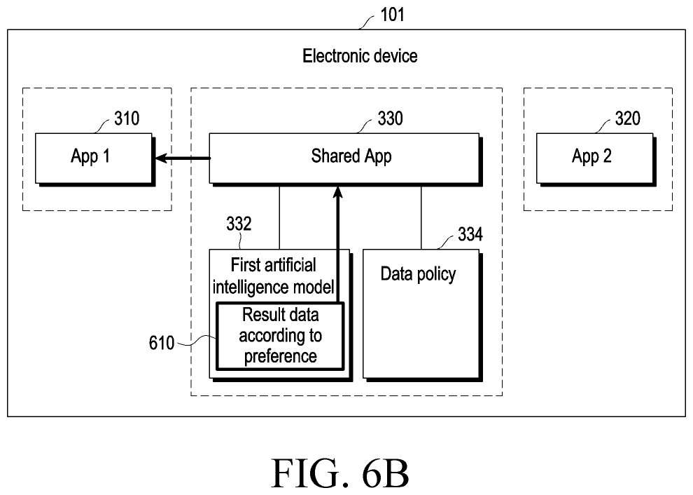

FIG. 5A is a diagram illustrating an example function or operation of controlling a first application 310 to provide a shared application 330 with first input data and first result data associated with the first application 310 to obtain result data estimated from an artificial intelligence model (e.g., the first artificial intelligence model 332) of the shared application 330 according to various embodiments. FIGS. 6A and 6B are diagrams illustrating an example function or operation of controlling a shared application 330 to provide a first application 310 with result data estimated by an artificial intelligence model (e.g., a first artificial intelligence model 332) of the shared application 330 according to various embodiments.

Referring to FIG. 5A, the first application 310 according to an embodiment of the disclosure may transmit input data 510 input from the user and result data 520 estimated and/or determined by the second artificial intelligence model 312 to the shared application 330. The first application 310 according to an embodiment of the disclosure may transmit data to the shared application 330 under the guarantee that the shared application 330 does not leak the data provided from the first application 310. Such a guarantee may be performed through an application attestation function or operation of confidential computing according to an embodiment of the disclosure. The application attestation according to an embodiment of the disclosure may include a function or operation of identifying the integrity of the application through an integrity test and measurement. The input data 510 according to an embodiment of the disclosure may include a user utterance such as “Show me the photos and descriptions recently uploaded from app A (e.g., the second application 320).” The result data 520 according to an embodiment of the disclosure may include at least one image and descriptions according to various description methods for the image. In this case, although not shown in FIG. 5A, when the user's feedback information for the result data 520 is stored in the electronic device 101, the user's feedback information for the result data 520 may also be transmitted to the first artificial intelligence model 332. The first artificial intelligence model 332 according to an embodiment of the disclosure may perform training using the transmitted feedback information. The first artificial intelligence model 332 according to an embodiment of the disclosure may estimate and/or determine the priority for at least one result included in the result data 520 based on the training result. The shared application 330 according to an embodiment of the disclosure may transmit the result data 610 (refer, e.g., to FIGS. 6A and 6B) according to the preference to the first application 310.

FIG. 5B is a diagram illustrating an example function or operation of controlling a first application 310 to provide a shared application 330 with first input data associated with the first application 310 to obtain result data estimated from an artificial intelligence model (e.g., the first artificial intelligence model 332) of the shared application 330 according to various embodiments.

Referring to FIG. 5B, the first application 310 according to an embodiment of the disclosure may transmit input data 510 input from the user to the shared application 330. The input data 510 according to an embodiment of the disclosure may include a user utterance such as “Show me the photos and descriptions recently uploaded from app A (e.g., the second application 320).” In this case, although not shown in FIG. 5B, when the user's feedback information for the input data 510 is stored in the electronic device 101, the user's feedback information for the result data 520 may also be transmitted to the first artificial intelligence model 332. The first artificial intelligence model 332 according to an embodiment of the disclosure may perform training using the transmitted feedback information. The first artificial intelligence model 332 according to an embodiment of the disclosure may estimate and/or determine at least one result value based on the training result. The first artificial intelligence model 332 according to an embodiment of the disclosure may estimate and/or determine priority for the estimated and/or determined at least one result value. The shared application 330 according to an embodiment of the disclosure may transmit the result data 610 (e.g., refer to FIGS. 6A and 6B) according to the preference, based on the estimated and/or determined priority, to the first application 310 in operation 240 of FIG. 2.

Returning back to FIG. 2, the electronic device 101 according to an embodiment of the disclosure may, in operation 250, provide at least one result for the third user input data to the user based on the transmitted result. The electronic device 101 according to an embodiment of the disclosure may provide a result of the third user input data to the user through the display module 160 for the result of the highest priority.

FIG. 7 is a flowchart illustrating an example function or operation of providing at least one application (e.g., a first application) with result data estimated by an artificial intelligence model (e.g., a first artificial intelligence model) of a shared application 330 according to a data policy 334, according to various embodiments.

Referring to FIG. 7, in operation 710, the electronic device 101 according to an embodiment of the disclosure may control the first application 310 or the second application 320 to transmit input data from the first application 310 or the second application 320 to the shared application 330. In operation 720, the electronic device 101 according to an embodiment of the disclosure may determine whether the first application 310 or the second application 320 meets the data policy 334. Operation 720 according to an embodiment of the disclosure may be performed by, e.g., the shared application 330. The data policy 334 according to an embodiment of the disclosure may include, e.g., a policy for providing result data when data is transmitted to the shared application 330 a designated number of times or more. According to an embodiment of the disclosure, when data is not transmitted to the shared application 330 a designated number of times or more, the first application 310 or the second application 320 may not receive the result data from the shared application 330 (operation 720—No). In operation 730, when the first application 310 or the second application 320 is an application that meets the data policy 334, the electronic device 101 according to an embodiment of the disclosure may transmit result data to the first application 310 or the second application 320 (operation 720—Yes). Identification of the data policy 334 according to an embodiment of the disclosure may be performed, e.g., when a designated function (e.g., feed_data( )) is called, but is not limited thereto.

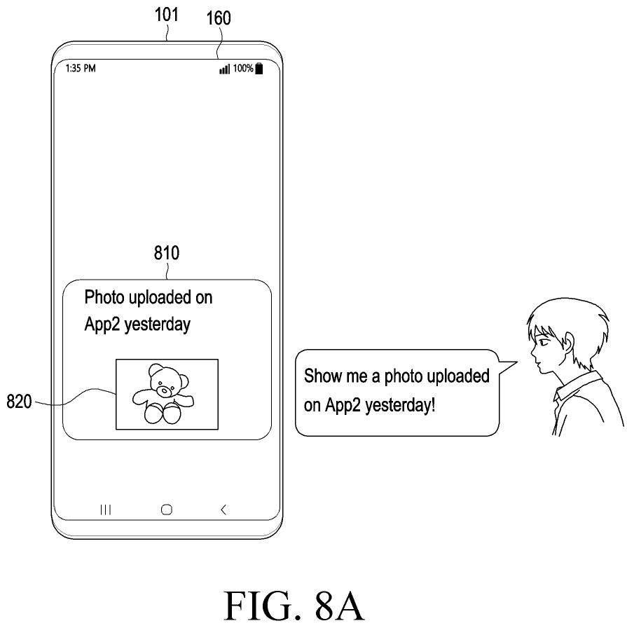

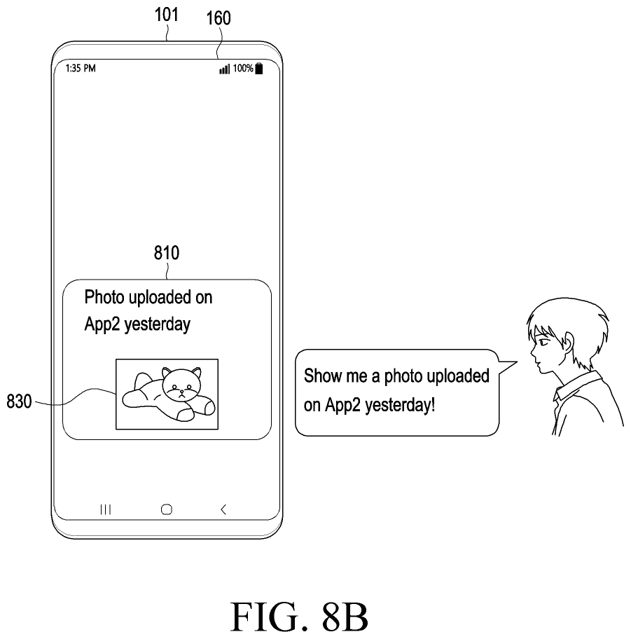

FIGS. 8A and 8B are diagrams illustrating an example function or operation in which an electronic device 101 provides a user with result data different from result data before training, based on a result of training based on input data input through a plurality of applications (e.g., the first application 310 and the second application 320) according to various embodiments.

Referring to FIGS. 8A and 8B, if having provided result data (e.g., a first description 810 and a second result image 820) using the first application 310 before training using data associated with the second application 320, the electronic device 101 according to an embodiment of the disclosure may provide result data (e.g., the first description 810 and a third result image 830) using the first application 310 after training data associated with the second application 320, thus transmitting result data matching the user's intent as compared with the conventional art. The second result image 820 and the third result image 830 may include an image associated with the second application 320 or stored for the second application 320.

An electronic device (e.g., the electronic device 101 of FIG. 1) according to an example embodiment of the disclosure may comprise: memory (e.g., the memory 130 of FIG. 1) and at least one processor (e.g., the processor 120 of FIG. 1), comprising processing circuitry. At least one processor, individually and/or collectively, may be configured to cause the electronic device to: transmit, to a shared application, first user input data input through a first application corresponding to a first vendor and second user input data input through a second application corresponding to a second vendor, stored in the memory, train a first artificial intelligence model of the shared application based on the first user input data and the second user input data, estimate results of a third user input data input through the first application or the second application, through the first artificial intelligence model, based on training the artificial intelligence model, and determine a priority for the estimated results and transmit information about the determined priority and the estimated results to the first application or the second application.

According to an example embodiment of the disclosure, at least one processor, individually and/or collectively, may be configured to cause the electronic device to: control the first application and the second application to provide first result data estimated by a second artificial intelligence model of the first application for the first user input data and first feedback information for the first result data, and second result data estimated by a third artificial intelligence model of the second application for the second user input data and second feedback information for the second result data to the shared application, for the training.

According to an example embodiment of the disclosure, at least one processor, individually and/or collectively, may be configured to cause the electronic device to: identify whether the first application and the second application are applications meeting a designated privacy policy, wherein the designated privacy policy may include a policy configured to transmit the information about the determined priority and the estimated results for an application transmitting data to the shared application a designated number of times or more.

According to an example embodiment of the disclosure, the first application, the second application, and the shared application may be executed under a confidential computing environment.

According to an example embodiment of the disclosure, the first vendor and the second vendor may include different vendors, and data stored for the first application may not be directly provided to the second application.

According to an example embodiment of the disclosure, at least one processor, individually and/or collectively, may be configured to cause the electronic device to: control the first application and the second application to provide first feedback information for the first user input data and first feedback information for the second user input data from the first application and the second application, respectively, to the shared application.

According to an example embodiment of the disclosure, at least one processor, individually and/or collectively, may be configured to cause the electronic device to: control the first application or the second application to transmit at least one of the first user data or the second user data to the shared application based on a result of application attestation on the shared application.

The electronic device according to various embodiments of the disclosure may be one of various types of electronic devices. The electronic devices may include, for example, a portable communication device (e.g., a smart phone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each component (e.g., a module or a program) of the above-described components may include a single entity or multiple entities. Some of the plurality of entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment of the disclosure, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
memory storing one or more computer programs; and
at least one processor, comprising processing circuitry, communicatively coupled to the memory,
wherein the one or more computer programs include computer-executable instructions wherein, at least one processor, individually or collectively, is configured to execute the instructions and to cause the electronic device to:
transmit, to a shared application, first user input data input through a first application, corresponding to a first vendor and stored in the memory, and second user input data input through a second application, corresponding to a second vendor and stored in the memory;
based on the first user input data and the second user input data, train a first artificial intelligence model of the shared application;
based on the training of the artificial intelligence model, estimate, through the first artificial intelligence model, results of third user input data input through the first application or the second application; and
determine a priority for the estimated results and transmit information about the determined priority and the estimated results to the first application or the second application.

2. The electronic device of claim 1,
wherein at least one processor, individually or collectively, is configured to cause the electronic device to:
control, for the training, the first application to provide, to the shared application, first result data estimated by a second artificial intelligence model of the first application for the first user input data and first feedback information for the first result data, and
control, for the training, the second application to provide, to the shared application, second result data estimated by a third artificial intelligence model of the second application for the second user input data and second feedback information for the second result data.

3. The electronic device of claim 1,
wherein at least one processor, individually or collectively, is configured to: cause the electronic device to identify whether the first application and the second application are applications satisfying a designated privacy policy, and
wherein the designated privacy policy includes a policy configured to transmit the information about the determined priority and the estimated results for an application transmitting data to the shared application a designated number of times or more.

4. The electronic device of claim 1,
wherein the first application, the second application, and the shared application are configured to be executed under a confidential computing environment.

5. The electronic device of claim 1,
wherein the first vendor and the second vendor are different vendors from each other, and
wherein data stored for the first application is configured to not be directly provided to the second application.

6. The electronic device of claim 1,
wherein at least one processor, individually or collectively, is configured to cause the electronic device to:
control, for the training, the first application to provide, to the shared application, the first feedback information for the first user input data from the first application, and
control, for the training, the first application to provide, to the shared application, the first feedback information for the second user input data from the second application.

7. The electronic device of claim 1,
wherein at least one processor, individually or collectively, is configured to cause the electronic device to, based on a result of application attestation on the shared application, control the first application or the second application to transmit at least one of the first user data or the second user data to the shared application.

8. A method for controlling an electronic device, comprising:
transmitting, to a shared application, first user input data input through a first application, corresponding to a first vendor and stored in memory of the electronic device, and second user input data input through a second application, corresponding to a second vendor and stored in the memory;
based on the first user input data and the second user input data, training a first artificial intelligence model of the shared application;
based on the training of the artificial intelligence model, estimating, through the first artificial intelligence model, results of third user input data input through the first application or the second application; and
determining a priority for the estimated results and transmitting information about the determined priority and the estimated results to the first application or the second application.

9. The method of claim 8, further comprising:
controlling, for the training, the first application to provide, to the shared application, first result data estimated by a second artificial intelligence model of the first application for the first user input data and first feedback information for the first result data, and
controlling, for the training, the second application to provide, to the shared application, second result data estimated by a third artificial intelligence model of the second application for the second user input data and second feedback information for the second result data to the shared application.

10. The method of claim 8, further comprising:
identifying whether the first application and the second application are applications satisfying a designated privacy policy,
wherein the designated privacy policy includes a policy configured to transmit the information about the determined priority and the estimated results for an application transmitting data to the shared application a designated number of times or more.

11. The method of claim 8,
wherein the first application, the second application, and the shared application are configured to be executed under a confidential computing environment.

12. The method of claim 8,
wherein the first vendor and the second vendor are different vendors from each other, and
wherein data stored for the first application is configured to not be directly provided to the second application.

13. The method of claim 8, further comprising:
controlling, for the training, the first application to provide, to the shared application, the first feedback information for the first user input data from the first application, and
controlling, for the training, the second application to provide, to the shared application, the first feedback information for the second user input data from the second application.

14. The method of claim 8, further comprising:
based on a result of application attestation on the shared application, transmitting at least one of the first user data or the second user data to the shared application.

15. Non-transitory computer-readable storage media storing one or more computer programs including computer-executable instructions that, when executed by at least one processor, comprising processing circuitry, individually and/or collectively, of an electronic device, cause the electronic device to perform operations, the operations comprising:
transmitting, to a shared application, first user input data input through a first application, corresponding to a first vendor and stored in memory of the electronic device, and second user input data input through a second application, corresponding to a second vendor and stored in memory of the electronic device;
based on the first user input data and the second user input data, training a first artificial intelligence model of the shared application;
based on the training of the artificial intelligence model, estimating, through the first artificial intelligence model, results of third user input data input through the first application or the second application; and
determining a priority for the estimated results and transmit information about the determined priority and the estimated results to the first application or the second application.

16. The non-transitory computer-readable storage media of claim 15, wherein the operations further comprise:
controlling, for the training, the first application to provide, to the shared application, first result data estimated by a second artificial intelligence model of the first application for the first user input data and first feedback information for the first result data, and
controlling, for the training, the second application to provide, to the shared application, second result data estimated by a third artificial intelligence model of the second application for the second user input data and second feedback information for the second result data.

17. The non-transitory computer-readable storage media of claim 15,
wherein the operations further comprise identifying whether the first application and the second application are applications satisfying a designated privacy policy, and
wherein the designated privacy policy includes a policy configured to transmit the information about the determined priority and the estimated results for an application transmitting data to the shared application a designated number of times or more.

18. The non-transitory computer-readable storage media of claim 15,
wherein the first application, the second application, and the shared application are configured to be executed under a confidential computing environment.

19. The non-transitory computer-readable storage media of claim 15,
wherein the first vendor and the second vendor are different vendors from each other, and
wherein data stored for the first application is configured to not be directly provided to the second application.

20. The non-transitory computer-readable storage media of claim 15,
wherein the operations further comprise: controlling, for the training, the first application to provide the first feedback information for the first user input data from the first application, and
controlling, for the training, the second application to provide the first feedback information for the second user input data from the second application.
